(19) United States
(12) Patent Application Publication
(10) Pub. No.: US 2014/0004490 A1
(43) Pub. Date: Jan. 2, 2014

(54) System And Method Facilitating Selection of Techniques And Aids For Child Behavior Modification

(71) Applicant: The Procter & Gamble Company, Cincinnati, OH (US)

(72) Inventors: Jane Hooper Welling, Cincinnati, OH (US); Vickie Lee Streithorst, Cincinnati, OH (US); Theodora Beck, Cincinnati, OH (US); Reginald Edward Crutcher, Cincinnati, OH (US)

(21) Appl. No.: 13/930,483

(22) Filed: Jun. 28, 2013

Related U.S. Application Data
(60) Provisional application No. 61/666,092, filed on Jun. 29, 2012.

(51) Int. Cl. G09B 19/00

(52) U.S. Cl. CPC G09B 19/00
USPC 434/236

(57) ABSTRACT

A method and system for facilitating the selection of a particular pre-determined program to be used by a caregiver and child for modification of the child's behavior are disclosed. The method involves causing the caregiver to respond to psychometric queries about themself and the child, categorizing the caregiver and the child into pre-determined caregiver and child categories based on the caregiver's responses to the queries, and categorizing the caregiver and child into one of a number of caregiver-child pairings each having a pre-assigned particular behavior modification program. The system associates equipment configured to contain and use information and enable practice of the method. In one embodiment, the behavior modification is toilet training of a child.

### BACKGROUND OF THE INVENTION

Parents and other caregivers of babies and young children, particularly inexperienced caregivers, undergo substantial anxiety in raising and guiding their babies and young children through various stages of development. One stage of development that may be a substantial source of anxiety is toilet training.

Toilet training is significant because it is one of the very early stages of development in which a child can begin to exert their will and control. Once a child becomes continent (conscious of the need to void and physically and consciously able to refrain from doing so for a period of time and/or induce it at will), the child is in a position to make a conscious choice that will please or frustrate their caregiver. There is usually a learning period between the time the child begins to perceive physical sensations of the need to void and recognizes some ability to exert control, and the time they are able to intentionally exert control and choose to hold or void. During this learning period the caregiver can have a large impact on the process. Caregivers naturally want their children to be happy, while developing behavior and habits that are deemed normal, healthy and socially desirable. When caregiver and child do not effectively communicate and/or cooperate in the toilet training process, delay of success and stress on both caregiver and child may result.

There is a large quantity of published information and product offerings available that purport to provide guidance and help with child toilet training—myriad books and magazine articles by doctors and other experts, published information on the internet, potty chairs and related devices, various success tracking and reward systems, tools, etc. The quantity of such materials available may be so large as to be overwhelming to some, and therefore, unhelpful. Each caregiver and each child have their own personality traits and abilities, and some personality pairings are more innately cooperative than others. Techniques and tools that work well for some caregiver-child personality pairs may not necessarily work well for others. When a caregiver-child pair attempt toilet training using one or more particular techniques, and experience failure (in the form of delay in reaching the objective despite the child's physiological and emotional readiness), stress and anxiety can be exacerbated for one or both of caregiver and child. Delay or setbacks can even become a source of needless anxiety concerning the child's health, or embarrassment and unexpected difficulty in daily routines.

For these reasons it would be advantageous if means were available to help a caregiver easily and quickly identify and implement a toilet training program, including training techniques and tools, that reduces stress and anxiety, reduces changes of regression, improves confidence, and improves chances of success (i.e., relative ease and rapidity) in toilet training their child.

### BRIEF DESCRIPTION OF THE DRAWING

FIG. 1 is a schematic flowchart depiction of an example of a system and process for selecting a toilet training program and presenting information concerning the program to a caregiver.

### DESCRIPTION OF THE INVENTION

Considerable study has been devoted to identifying and categorizing caregiver (typically, parent) personality types from the perspective of the nature of the caregiver's approach to their relationship and interactions with their child. Researchers have identified three broad categories: “permissive” (herein, “P”), “authoritative” (herein, “Av”), and “authoritarian” (herein, “An”). For an early and often-cited example, see D. Baumrind, Child Care Practices Anteceding Three Patterns of Preschool Behavior, Genetic Psychology Monographs 75(1), at p. 43 (1967), As the categories are described generally in the literature, the P parent tends to behave in anon-punitive, acceptant and affirmative manner towards the child's impulses and actions, prefers to avoid confrontation, and tends not to use overt power to achieve their goals. The Av caregiver attempts to direct the child's activities and enforces rules and standards, but in a rational, issue-oriented manner, and encourages, acknowledges and values the child's input in a democratic manner. The An caregiver values order, structure and obedience and attempts to shape, control and evaluate the child's behavior and attitudes in accordance with strict rules and a set standard of conduct, without substantial consideration of the child's input or unique needs can be appreciated that most adults will have traits from more than one of these broad categories, but it is believed generally that traits from one of the three categories will be predominant, and therefore suggest categorization. Some literature identifies a fourth parenting personality/trait category, referred to as “uninvolved.” However, it is believed that people who are identifiable with this category generally do not substantially contribute to toilet training, and, therefore, this category is not deemed significant for purposes herein.

Similarly, considerable study has been devoted to identifying and categorizing child personality types from the perspective of the child's behavior and relationship with their caregivers and others with whom they interact. See, e.g., S. Chess and A. Thomas, Temperament: Theory and Practice (Brunner/Mazel 1996). Researchers have identified four broad categories: “easy going” (herein, “EG”), “slow to warm up” (herein, “SW”), “difficult” (herein, “D”), and “mixed profile” (herein, “M”). The EG child is viewed as regular, highly adaptable, approaching/approachable, displaying emotions with low intensity, and generally positive in mood. The SW child is viewed as slow to adapt to new situations and circumstances, withdrawn at first, displaying emotions with mild intensity, and sometimes negative in mood. The D child is viewed as irregular, even slower to adapt to certain situations and fearful of new people and situations, often withdrawing, and displaying emotions with intensity. The M child is viewed as exhibiting a combination of characteristics from two or more of the first three categories. In many cases, however, M children exhibit characteristics and/or behavior from one of the other categories that, under circumstances attendant to toilet training, may be deemed predominate. Accordingly, for purposes of toilet training many M children may be classified in one of the other categories. Additionally, for purposes herein, another potentially relevant category, “strong-willed” (herein, “ST”) has been identified through research conducted for purposes herein. The ST child is believed to present stubborn or controlling characteristics which may present difficulties in the context of toilet training.

It is believed that at least some of a child's temperament traits are, however imparted, innate, and not the result of external experiences and circumstances including parent/caregiver personalities. At the same time, it is believed that external experiences and circumstances including the caregiver personalities and parenting/caregiving styles may have a modifying effect. For a particular child personality category, some parenting/caregiving styles may be better suited to have positive modifying effects than others. It will be appreciated, therefore, that a one-size-fits-all approach to toilet training, or an approach that does not take into account the individual personalities of the caregiver and child, might not be as effective for improving chances of success and/or reducing stress and anxiety of the process, as a more carefully selected approach. It will be appreciated, further, that a caregiver may lack the tools and knowledge to recognize and identify their parenting style and their child's temperament characteristics, and to identify and implement toilet training techniques that are adapted to meet the psychological, emotional and/or cognitive needs of both.

Researchers have developed psychometric techniques for categorizing caregiver and child personalities according to the categories described above. These techniques typically include specially designed questions or queries to be posed to the caregiver, concerning their attitudes, actions, practices and beliefs, and concerning their child's behavior in various circumstances. The caregiver's responses to these psychometric queries may be used to categorize the caregiver's personality type and the child's personality type.

Without intending to be bound by theory, it is believed that these caregiver and child personality categories, and psychometric tools for categorization, may be applied and useful in the context of toilet training. It is believed that categorizing a caregiver and their child into respective applicable personality categories may be useful to select a set of training techniques and tools for use in a toilet training program that is more likely to ensure a successful toilet training experience and reduce the likelihood and/or level of stress and anxiety for the caregiver-child pair, as compared with an unguided approach.

The caregiver may be presented with a first number of psychometric queries concerning their attitudes, actions, preferences and/or beliefs concerning parenting. For example, the following non-limiting examples may be useful in the context of toilet training:

| Category | Example Queries Concerning Caregiver |
|---|---|
| Permissive P | I don't have a lot of strict rules when it comes to my |
| | toddler. |
| | I try to maintain peace with my toddler and avoid any type |
| | of confrontation or argument. |
| | You can never do too much for your toddler when it comes |
| | from genuine love. |
| Authoritative | I like giving my toddler choices when it is appropriate. |
| Av | When I come up against a task that it difficult with my |
| | toddler, I try to find an appropriate solution so we may |
| | complete the task. |
| | Childhood is so short that we should do everything to make |
| | it a happy time for my toddler. |
| Authoritarian | I make the rules for my toddler and he/she has to follow |
| An | them. |
| | I believe in strict discipline and structure for my toddler |
| | because it is the right way to be a good parent. |
| | I tell my toddler what has to be done and that it needs to be |
| | done my way. |

The caregiver may, for example, be asked to give a response to each query in the form of a choice of one of several options such as “strongly disagree,” “disagree,” “agree,” or “strongly agree” (hereinafter, “extent of agreement” or “EOA” response). The caregiver's responses may be scored or weighted in any appropriate manner to indicate a predominance of a particular caregiver personality type, and assignment to the associated category. It is believed that predominance in one of these groups of queries make categorization in the indicated personality type appropriate.

Similarly, the caregiver may be presented with a second number of psychometric queries concerning behavior exhibited by their child in various circumstances. The following non-limiting examples may be useful in the context of toilet training:

| Category | Example Queries Concerning Child |
|---|---|
| Easy Going | My toddler easily accepts changes to his/her routine. |
| EG | My toddler is comfortable when he/she is in a new |
| | situation. |
| | My toddler likes to be the “star” of the group. |
| Slow Warm Up | I need to take my toddler to new events or new situations |
| SW | several times before he/she feels comfortable. |
| | My toddler is relatively quiet when he/she does new |
| | things, rather than being vocal or outgoing. |
| | My toddler tends to be the more shy or quiet one |
| | when in a group. |
| Difficult D | Most of the time, my toddler cannot sit still. |
| | At times my toddler seems to show more intense |
| | emotional reactions than other toddlers. |
| | My toddler does whatever his/her siblings or play |
| | friends are doing. |
| Strong Willed | My toddler has definite opinions on how to do things |
| ST | and it can be very difficult for me to change his/her |
| | mind. |
| | My toddler likes and wants to be in control to decide |
| | what he/she wants to do and how to do it. |
| | My toddler tries to control others in most situations. |

The caregiver may, for example, be asked to give an EOA response to each query. The caregiver's responses may be scored or weighted in any appropriate manner to indicate a predominance of a particular child personality type, and assignment to the associated category. It is believed that predominance in one of these groups of queries make categorization in the indicated personality type appropriate.

It will be recognized that the particular queries selected may be formulated with the context of toilet training in mind, and may vary in substance, form and number; and research concerning the best approach may reveal preferred forms and refinements. At the same time, it is believed that the general approach described herein is effective for the described purpose.

It is also contemplated that, in some circumstances, responses to an initial set of queries may be inconclusive in that they do not indicate predominance in any one category for the caregiver and/or child. In such circumstances, a second set of additional queries may be presented to the caregiver. The additional queries may be, for example, more detailed, or more focused on particular situations such as, by way of non-limiting example, toilet training. They may be weighted differently. The additional queries may be designed and/or selected so as to be suitable to provide a deeper inquiry into more subtle or ambiguous personality types, relevant to the context of toilet training. In the context of toilet training, following are possible non-limiting examples:

| Example Additional Queries Concerning | |
|---|---|
| Caregiver and Child (caregiver selects | |
| statement with which they most agree) | Selection Indicates: |
| Thinking about potty training my toddler: | |
| My toddler and I will work together as a team | Av Caregiver |
| when we begin potty training. | |
| I will be in complete charge of potty training | An Caregiver |
| and expect my toddler to do what I tell | |
| him/her to do | |
| It will be more about my toddler putting | P Caregiver |
| in most of the effort to potty train, rather | |
| than me. | |
| The effort will be split between me and my | P Caregiver indicated for |
| toddler: | response 30/70 or less |
| % me | caregiver/toddler |
| % toddler | |
| I will need to let my toddler feel like | ST Child |
| everything is his/her idea, otherwise he/she | |
| won't participate in potty training. | |

It is believed that, in some circumstances, a caregiver's ego could become a factor and influence their responses to queries of this nature, compromising objectivity. However, it is believed that the caregiver's interest in doing what they believe is best for them and their child may have a countervailing influence, and promote objectivity. Further, the queries need not be presented to the caregiver in any particular order or grouping; to the contrary, randomizing their order may help reduce the chances that the caregiver will recognize the specific thrusts of the individual queries, and thereby promote objectivity. Additionally, the system described below may help make this querying process “blind,” in that the caregiver does not know the precise thrust of the queries, or how their responses will be used, and so will make it less likely that they will give responses that are not objective.

After the caregiver has provided responses to first and second numbers of psychometric queries concerning their and their child's personalities, such as, for example, those described above, their respective personalities may be categorized according to the responses, i.e., the caregiver may be categorized as predominately one of P, Av or An, and the child may be categorized as predominately one of EG, SW, D or ST. These respective categorizations may then be placed in one of a number of possible pairings of the caregiver's and child's personality categories. For example, the following table depicts 12 possible pairings using the examples of personality categories described above:

Caregiver Category

| Child Category | P | Av | An |
|---|---|---|---|
| EG | P-EG | Av-EG | An-EG |
| SW | P-SW | Av-SW | An-SW |
| D | P-D | Av-D | An-D |
| ST | P-ST | Av-ST | An-ST |

The number of possible pairings will be a factor of the number of caregiver categories and the number of child categories used.

Significantly, it can be seen that the numbers of psychometric queries presented to the caregiver, of respective caregiver and child personality categories used, and of possible pairings, are finite. This enables identification of a finite (i.e., manageable) number of pre-determined toilet training programs that each includes techniques and physical aids that have been pre-selected for a pairing, and assignment of a toilet training program to each of the possible pairings. Further, in order to keep the system simple and easy for the caregiver, i.e., not overly time consuming, cumbersome or confusing, it may be desirable to limit the number of queries presented to the caregiver. For example, it may be desirable to limit the number of queries posed to the caregiver to 20 or fewer, more preferably 15 or fewer, and still more preferably 10 or fewer, for caregiver categorization; 25 or fewer, more preferably 20 or timer, and still more preferably, 15 or fewer, for child categorization. Alternatively, it may be preferable that the total number of queries presented for both caregiver and child categorization is limited to 45 or fewer, more preferably 35 or fewer, and still more preferably 25 or fewer.

Once the caregiver has provided responses to the queries, the caregiver and child have each been categorized, and their particular pairing identified, the pairing may be used to indicate which of a number of toilet training programs including pre-selected toilet training techniques and physical tools has been pre-determined to be used by the pairing, and thus, may be made available to be provided to the caregiver.

In some circumstances, particularly if the child is young compared with the average age at which children of their demographic group undergo toilet training, it may be desired to present the caregiver with an additional set of queries designed to enable a conclusion whether the child is physiologically and emotionally ready, to begin toilet training. Children develop continence (herein meaning that the child is conscious of the need to void, and is physically and consciously able to refrain from doing so for a period of time) at varying ages. In some circumstances a caregiver may be tempted to urge a child to engage in toilet training before the child is continent. In this situation the likelihood of failure is substantially increased, and the resulting anxiety and stress may be counterproductive to toilet training when the child actually becomes ready.

Similarly, caregiver readiness may be an important factor for successful toilet training. It is believed that a caregiver should not be urged to undertake toilet training with the child until they feel like they are ready to do so under their own circumstances. If the caregiver is not ready, their attitude and interactions with the child may reflect a feeling of being harried, or anxious and uncertain of the approach—which may negatively impact the experience.

Accordingly, reaching a determination that the child and parent both are ready for toilet training may be deemed a desirable prerequisite to engaging in toilet training. Non-limiting examples of additional queries that may be presented to the caregiver for this purpose are as follows:

| | | Type of Response |
|---|---|---|
| | Example Queries Concerning Readiness | Requested |
| Child | Is your toddler at least 24 months old? | Yes/No |
| Readiness | Is your toddler able to tell you what he/she wants by putting together 2-3 | Yes/No |
| | word sentences? | |
| | Does your toddler tell you he/she does not like being in a dirty diaper, or does | Yes/No |
| | your toddler ask to be changed when his/her diaper is soiled? | |
| | Does your toddler stay dry for at least 2 hours during the day? | Yes/No |
| | Does it bother your toddler when he/she has soiled his/her diaper? | Yes/No |
| | Is your toddler able to pull down his/her clothing, pants, pull-ups, etc.? | Yes/No |
| | Does your toddler show interest in learning to use the toilet? | Yes/No |
| | Do you think your toddler would vadily cooperate in potty training? | Yes/No |
| Caregiver | I feel like my toddler is getting too old to be wearing diapers or disposable | Yes/No |
| Readiness | training pants. | |
| | I am seeing definite signals from my toddler that he/she needs to void. | Yes/No |
| | I am ready to devote the necessary extra time and effort to potty train my | Yes/No |
| | toddler now. | |

| Caregiver | How “READY” do you think YOUR TODDLER and YOU are ready to begin potty training RIGHT | | |
|---|---|---|---|
| and Child | NOW? | | |
| Pair | | Your Toddler | You |
| Readiness | Extremely ready | | |
| | Very ready | | |
| | Somewhat ready | | |
| | Slightly ready | | |
| | Not ready at all | | |

The caregiver's responses to queries of the nature reflected above may be weighted in various ways to reach a determination whether the child and caregiver are ready to begin toilet training. It is particularly important that the child be physiologically and emotionally ready. If the child is not yet ready, it may be recommended that implementation of toilet training be delayed for a period of time, at least until a time when the caregiver's responses to such queries indicate child readiness.

In conjunction with, or as an alternative to, use of queries as described above for determining child readiness, any of a number of devices used in connection with a diaper or other wearable absorbent article may be employed, to detect, record and log urination events, and enable conclusions concerning whether the child is continent. Such devices are described in, for example, U.S. Pat. Nos. 7,449,614; 7,659,815; 7,504,550; 7,834,235; 7,700,820; 7,846,383; 7,524,195; 7,753,691; 7,850,470; 7,667,608; 7,700,821; 7,760,101; 6,603,403; 7,477,156; 7,649,125; 7,498,478; 7,355,090; 7,737,322; 7,489,252; and 7,595,734; U.S. Pat. Apps. Pub. Nos. 2008/0051745; 2008/0058740; 2008/0058741; 2008/0057693; 2008/0054408; 2008/0058745; 2008/0082062; 2008/0082063; 2008/0147030; 2008/0243099; 2010/0248507; 2008/0266117; 2008/0266122; 2008/0266123; 2008/0269703; 2009/0005748; 2009/0036850; 2009/0036012; 2009/0036015; 2009/0058072; 2009/0062756; 2009/0098367; 2009/0124990; 2009/0155753; 2009/0321238; 2009/0315728; 2009/0326409; 2009/0326492; 2009/0326417; 2009/0326491; 2010/0030173; 2010/0114046; 2010/0114047; 2010/0145294; 2010/0152688; 2010/0152690; 2010/0159611; 2010/0159599; 2010/0155006; 2010/0164733; 2010/0168702; 2010/0168694; 2007/0142796; 2007/0252712; 2007/0255241; 2007/0255242; 2007/0282286; and 2008/0052030; U.S. patent application Ser. Nos. 13/483,456 and 13/483,463; and European Pat. No. EP 1 962 757.

Such devices also may be used in a system configured and equipped to record and log the times during the day at which a continent child typically voids over a several-day period preceding implementation of toilet training program. This void history information can enable prediction, for the near future, times during the day in which the child is likely to void. It may be appreciated that void history information may also be obtained through caregiver observation, i.e., noting the times at which the child voids, for several (e.g., at least two, more preferably at least three, and still more preferably four to seven days.) days prior to implementation of a toilet training program. Observation and accuracy thereof may be assisted and improved through use of any number of diapers, training pants and associated devices designed to detect urination; examples are sometimes known as “wetness indicators,” “wetness detectors,” etc. and are disclosed in, e.g., the above-identified references, as well as U.S. Pats. Nos. 7,977,528; 7,915,476; 7,910,797; 7,838,720; 7,834,234; 7,781,640; 7,767,876; 7,767,875; 7,705,194; 7,615,675; 7,332,642; 7,159,532; 7,002,055; 6,904,865; 6,772,708; 6,657,100; 6,642,427; 6,576,810; 6,342,037; 5,797,892; 5,702,377; 5,702,376; 5,649,914; 4,231,370; 3,794,024; and 3,675,654; and U.S. Apps. Pub. Nos. 2009/0221980; 2008/0071239; 2008/0058745; 2007/0287971; 2007/0233028; 2007/0233026; 2006/0229578; 2006/0229577; 2006/0142711; 2006/0069360; 2005/0234414; 2005/0228349; 2005/0222546; 2004/0030310; 2003/0164136; 2003/0154904; 2003/0153884; 2003/0145937; 2003/0125682; and 2002/0169427.

Void prediction information may be incorporated into a toilet training program that, for example, informs the caregiver that the child should be directed to attempt to use the toilet at or shortly prior to the predicted times (herein, such derivative information will be referred to as a “toilet schedule.”) Implementing a toilet schedule as part of a toilet training program can increase the likelihood that the child will have a substantial physical urge to void (i.e., have a quantity of urine in their bladder sufficient to trigger a substantial physical urge or trigger successful voiding) when they are directed to visit the toilet. This may increase the likelihood that the child will consciously identify their ability to control the muscles associated with bladder control, and associate the urge to void with a visit to the toilet, at a relatively early stage in the training process.

Research may be used to determine which types of toilet training techniques and physical aids are most likely to improve chances of toilet training success for particular pairings, and to make pre-determinations assigning one or more particular training techniques and physical aids to toilet training programs to be associated with particular pairings.

For example, it is believed that use of comforting transitional objects (one type of physical aid) with SW children is effective for helping them to learn toileting habits through demonstration (a technique), in which the transitional object (such as a stuffed toy animal) is ascribed the role of a “friend” learning to use the toilet. In some circumstances a child may already possess a favorite transitional object, which may be suitable for such use. Techniques involving such use of a transitional object may be incorporated into a toilet training program to be used by pairings that include SW children. On the other hand, use of such a transitional object may be unnecessary or even counterproductive in some circumstances, with, for example, an EG child, and so might not be deemed appropriate for inclusion in a toilet training program to be used by pairings that include EG children.

As another example, it is believed that techniques that include joint parent-child selection and decision making concerning such matters as, for example, the selection of a particular bathroom in the home in which to place the child potty seat, is effective for a pairing of an Av caregiver and SW child. Accordingly, such techniques may be incorporated into a toilet training program to be used by an Av-SW pairing. On the other hand, use of such democratic techniques may be unnecessary or even counterproductive with a pairing that includes an An caregiver and EG child, and so might not be deemed appropriate for inclusion in a toilet training program to be used by an An-EG pairing.

As another example, it is believed that a P caregiver would find a toilet training program that provides direction, information and instruction directly to the child, with relatively little caregiver input or interaction, highly appealing. Conversely, it is believed that An and in some circumstances Av caregivers are more likely to prefer providing direction and setting expectations and pace to a substantial extent themselves.

Additional inquiry may be made into the caregiver's preferences for the pace of a toilet training program. Personal circumstances and/or personality type may cause some caregivers to prefer a more rapid pace, and others to prefer a more relaxed pace. Non-limiting examples of queries that may be presented to caregivers for identifying the caregiver's preference in this regard are as follows:

| Example Queries Concerning Pace | |
|---|---|
| Preference (caregiver selects statement with | |
| which they most agree) | Selection Indicates: |
| Considering my and my toddler's current | |
| lifestyle and how I like thing to go: | |
| A potty training program that that takes as | Relaxed pace |
| long as it takes is OK with me. | |
| I would prefer a very fast, concentrated, | Rapid pace |
| few-day potty training program. | |
| Even if it takes a few weeks, as long as | Basic pace |
| I can see some progress, I would be comfortable | |
| using the potty training program. | |

It may be recognized that one particular toilet training technique, or one particular physical aid, or one particular program combining particular training technique(s) and physical aids, may be appropriate for more than one of the possible pairings identified.

It will be appreciated that the operations including (1) presenting chosen psychometric queries to the caregiver, (2) collecting caregiver responses to the queries, (3) categorizing the caregiver into one of a plurality of pre-determined caregiver categories, (4) categorizing the child into one of a plurality of pre-determined child categories, (5) identifying the caregiver and child pairing corresponding with the categorizations, (6) identifying a pre-determined toilet training program including pre-selected techniques and/or physical aids assigned to the identified pairing, and optionally, (7) providing the caregiver information/instructions according to the toilet training program, (8) tracking successful accomplishment of daily tasks that signify progress, and (9) providing pre-established matched feedback and encouragement to overcome obstacles or setbacks and continue use of the program may be performed via one or more multi-purpose computers, or alternatively specialized computers, adapted specifically for the application. It is believed that performance of these steps via one or more computers is practically necessary to provide a system that caregivers will find practical, convenient and effective (i.e., useful). Computers can provide relative speed, convenience and simplicity for the caregiver in presenting queries, collecting responses, processing responses and decision making. Additionally, computers enable features that promote caregiver objectivity in the toilet training program selection process, e.g., avoidance of disclosure of use of categories, categorization process, or selection process. Operations can be performed via a single computer system or a multi-computer system. Such computers may also be configured and/or programmed to receive and use void history information or void prediction information to create a toilet schedule, and incorporate the toilet schedule into the toilet training program.

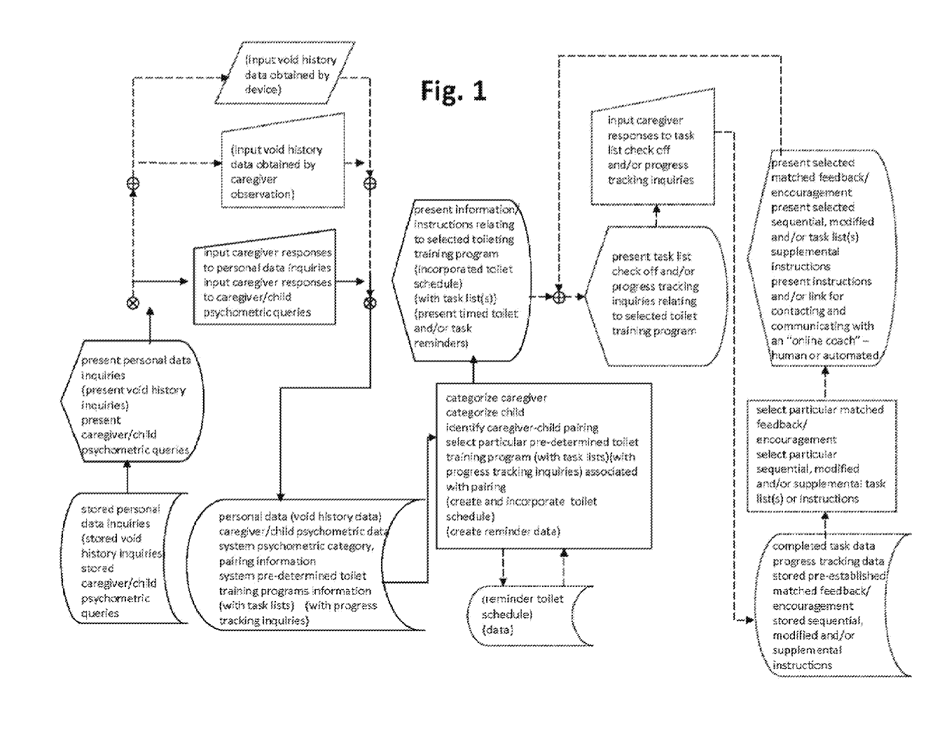

An example schematic flowchart illustrating use of stored information, presentation of information to the caregiver (via a display device such as a computer monitor or screen), collection/input of caregiver data, and processing data to identify information and further inquiries for additional information, is contained in FIG. 1. The dotted-line arrows and flowchart symbols represent optional additional steps, while the solid-line arrows and flowchart symbols represent steps that are more central to selecting a pre-determined toilet training plan that is suitable for use by a particular caregiver-child pairing. However, it is to be understood that the flowchart in FIG. 1 is only one example. It will be understood that the information used by the system that is pre-stored and collected/input by the caregiver may be stored on a single storage device or multiple storage devices. It will be understood that the system may collect/solicit information from a caregiver that is optional and/or supplemental to information needed to select an appropriate toilet training plan. It will be understood that the processes to be performed by the system may be performed on a single computer/processor or multiple computers/processors in communication. It will be understood that minor processes such as causing the display device to display stored information to the user, and conversion of user input into stored data, are not specifically depicted. The flowchart shown in FIG. 1 is not intended to restrict the claims below to a particular sequence or order of steps or processes. Rather, it wilt be recognized that a variety of sequences or orders of steps or processes may serve for purposes herein. Generally, the flowchart symbols used suggest use of the following system elements:

| | |
|---|---|
| 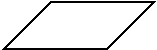 | Automatic data input device/interface |
| 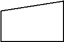 | Manual data input device (e.g., keyboard, keypad, touchscreen) |
| 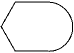 | Display device (e.g., computer monitor, screen) |
| 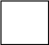 | Processor and supporting equipment |
| 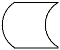 | Digital storage medium/device |

In one example, each of the steps in the process may be performed by a program running on a single computer. A computer program operable to perform and run the entire process may be provided, in a form operable to run on a desktop computer, laptop computer, tablet computer or handheld computer (e.g., smart phone) in the possession of the caregiver. The associated software may be delivered to the caregiver via Internet download, or via transportable digital storage medium (such as a CD, DVD, USB storage device or other storage device). Alternatively, the software may be loaded on a specialized computer provided and configured specifically for the purposes described herein.

In another example, a computer on which the program runs may be remote from the caregiver, and associated with a server operated by the operator or owner of the system, communicating with a computer controlled by the caregiver, via the Internet, wherein the caregiver's computer serves substantially as an interface and communication mechanism between the caregiver and the computer on which the program runs. In yet another example, a first portion of the operations of the system may run on a computer remote from the caregiver and controlled by the operator or owner of the system, and a second portion of the operations may run on a computer in the possession of the caregiver.

Upon identification of the caregiver-child pairing and identification of the pre-determined toilet training program associated with the pairing, a kit corresponding with the toilet training program may be provided in any of various forms. Informational/instructional elements provided may contain information describing and providing instructions concerning the particular toilet training technique(s) associated with the toilet training program, to be used by the caregiver with the child (herein, “information elements”), according to the pairing. Physical aids associated with the toilet training program and provided with the kit may include any associated physical objects to be used as aids in training process. A plurality of toilet training programs each including pre-selected techniques and physical aids may be identified, and each assigned to at least one particular caregiver-child pairing.

Information elements associated with the pre-determined toilet training programs may be made available. Information elements may be provided via any suitable medium, including printed media such as booklets, books, cards, papers and the like; digital media such as CDs, DVDs, or other portable digital storage media. Information elements also may be delivered via electronic mail to the caregiver, Internet download or interactive web page. They may be provided as direct output from the system following the caregiver's input of responses to the queries. They may be provided by, for example, applications which run or operate on devices such as tablet computers, smart phones and other handheld personal computers (e.g., iPAD and iPHONE devices (Apple Computer), and handheld personal computers operating on the ANDROID platform (Google)).

Physical aids that may be associated with one or more of the pre-determined toilet training programs may include (but are not limited to) objects such as potty chairs, child toilet seats, stools, flushable wet wipes, absorbent training underwear/pants, manual progress tracking charts, booklets, cards, boards and the like, physical game objects (such as, for example, “pee targets”), reward objects, transitional objects (such as, for example, dolls, stuffed animals, character dolls or figures, anthropomorphic dolls or figures, and like objects to which children may ascribe human characteristics, thoughts and emotions, or onto which children may project their own thoughts and emotions). Physical aids also may include media containing pictorial and/or videographic demonstrative and/or instructive materials adapted for viewing, listening, comprehension and/or use by the child, such as booklets, pictures, cards, CDs, DVDs, etc. Additional examples of informational/instructional elements and physical aids are described in, for example, U.S. Pats. Nos. 7,973,210; 7,540,741; 7,481,395; 6,896,521; 6,612,846; 6,250,929; and 5,725,382; and U.S. Apps. Pub. Nos. 2009/0326491; 2008/0045913; 2007/0045334; and 2005/0239024.

If not provided directly via computer interaction/user interface, the information elements may be made available to be provided by mail or Internet order and physical delivery, or may be made available for purchase or pick-up at, e.g., a retail store facility. Similarly, associated physical aids may be provided by Internet or mail order and physical delivery, or may be made available for purchase or pick-up at, e.g., a retail store facility. Physical aids may be either physically associated with information elements as in a toilet training program kit package, or may be physically separate but associated with the information elements by identification within the information elements. For example, a toilet training program kit may be provided containing information elements in the form of one or more booklets and/or DVDs and one or more physical aids. A plurality of assembled toilet training program kits, each associating pre-selected information elements and/or physical aids, may be made available for selection upon identification of an associated caregiver/child pairing.

A toilet training program kit may be provided and delivered (e.g., by mail or courier service) in response to the system's selection thereof and caregiver's confirmation of an order therefor, or may be made available for separately-placed order, or may be made available for purchase or pick-up at a retail store facility. As part of the system output, the caregiver may be directed to acquire the selected toilet training program kit, and provided instructions for acquiring it.

In some alternatives, however, the information elements corresponding to the assigned toilet training program may be provided to the caregiver via the same computer upon which the caregiver interacts with the system, either as direct output of the system, as a download, or via interactive web site. Should physical aids be a part of the associated technique(s), it would remain only to identify and, where necessary, provide the physical aids, via physical delivery, or to make them available for physical acquisition by the caregiver, e.g., at a retail store facility. For example, the system may be configured and programmed such that (1) the caregiver accesses an interactive web site via their computer; (2) the interactive web site presents the queries to the caregiver; (3) the caregiver inputs their responses to the queries via their computer; (4) the system uses the responses to the queries to (a) categorize the caregiver; (b) categorize the child; (c) identify the caregiver-child category pairing; and (d) identify the toilet training program that has been pre-selected for the pairing; and (5) the system presents information elements concerning the identified toilet training program to the caregiver via the caregiver's computer. The system also may be configured and programmed such that the caregiver may interact with the system to track successful accomplishment of daily tasks that signify progress, and (6) provide pre-established matched feedback and encouragement to overcome obstacles or setbacks and continue use of the program. As previously noted, the system may include and/or be used in conjunction with a toilet schedule, developed either through caregiver observation or use of void detection/recording/logging devices, prior to implementation of the toilet training program. A toilet schedule may be incorporated into the toilet training program.

The system may be configured to deliver information elements via the caregiver's computer (e.g., upon accessing the interactive web site) in the form of daily instructions. The daily instructions may take the form of or include a list of toilet-training tasks to be performed. In one possible non-limiting example, for, e.g., a first day of toilet training, the system may present a tasklist that includes any of the following items:
Choose a toilet training bathroom with (Child's name)
Set up a step stool and child potty seat insert at the toilet
Explain use of the toilet to (Child's name)
Show (Child's name) a soiled diaper, ask her if she knows what is in the diaper
Indicate whether (Child's name) expresses that she knows what is in the diaper
Watch the potty DVD
   The tasklist may include a feature by which the caregiver can “check off” the tasks as completed.

The system may also present additional daily inquiries to the caregiver concerning the child's progress. In one possible non-limiting example, for a day of toilet training, the system may present additional inquiries that include any of the following items:
Did (Child's name) pee in her diaper?
Did (Child's name) poop in her diaper?
Did (Child's name) pee in the toilet?
Did (Child's name) poop in the toilet?
Did (Child's name) pull down her own pants to use the toilet?
Did (Child's name) wash her hands after using the toilet?
How interested was (Child's name) in the potty break?

The system may be programmed to modify the next day's instructions/tasklist according to whether the caregiver has indicated that the current day's tasks have been completed, and/or according to the caregiver's responses to the additional daily inquiries.

As may be further appreciated, the system may be configured and programmed to present the information elements, instructions and tasks in personalized form, e.g., by using the caregiver's and child's names, etc. The system may be configured to present inquiries seeking information such as caregiver and child's first names, child's birthday, identification of child's favorite toys or activities, etc., to enable the system to include additional personalized features to the toilet training program, information elements, task/lists, etc. Additional inquiries that seek information about the caregiver and child and their lifestyle, that enable further personalization and improvement chances of success with the system, may be useful. For example, inquiries about the time(s) of day the child is most accepting of learning new activities; the time(s) of day the child is most likely to have longer attention span (or be able to sit quietly); and/or the time(s) of day most convenient for the caregiver to dedicate to toilet training activities, may be useful. Further inquiries concerning the child's preferences and interests may also be useful for, e.g., identifying suitable rewards or recognition for the child's successful completion of steps in the process.

The system also may be configured and programmed to cause a computer such as a tablet computer or smart phone to prompt the caregiver to perform particular daily tasks. For example, the system may be configured and programmed so as to be operable to cause a smart phone to display and/or sound a timed prompt/reminder to take the child to the toilet at a time indicated by the toilet schedule, in a manner similar to the way in which Microsoft OUTLOOK Calendar is configured and enabled to give a user an advance prompt/reminder of an upcoming appointment via the user's computer.

It may be desirable that the system perform its operations, particularly its presentation of queries to and collection of responses from the caregiver, in a “blind” fashion, i.e., such that the caregiver is not informed how their responses to the queries are used, is not informed of the personality categories and pairings into which the system places them and their child, and/or is not informed how a particular pre-determined toilet training program is selected for their pairing. This may be desirable because some caregivers may react negatively to information concerning the caregiver and child categories and/or the categorization process, which may cause them to reject the system, or to fail to be objective in responding to the queries. It may be most preferable that the caregiver is not expressly advised that they and/or their child are each being categorized into one of several pre-determined categories. If they are so advised, however, it may be preferable that they are not given a list of all or any subset of the labels of the categories from which the system chooses, to categorize them and their child. In the event it is desired that the caregiver be informed of the categorization process, it may be desirable not to use the particular traditionally-used category labels described above (i.e., “permissive,” “authoritative,” “authoritarian,” “easy” or “easy going,” “slow to warm up,” “difficult” or “strong willed”) because some of these words may have negative connotations for the caregiver, and they may take offense. (For example, a parent may be offended if the system tells them that their child is “slow to warm up” or “difficult.”) Rather, if the system's use of categories and/or the categorization process is to be revealed to the caregiver at all, it may be desirable to relabel the categories using words that are more likely to have mostly positive connotations. For example, the traditional caregiver category term “permissive,” might be relabeled “open-minded”; “authoritative” might be relabeled “democratic”; and “authoritarian” might be relabeled “orderly.” Similarly, the traditional child category term “slow to warm up,” might be relabeled “cautious,” and the traditional term “difficult” might be relabeled “particular”. It can be appreciated from the above discussion, however, that any labels one selects for the categories may cause a subjective reaction in the caregiver, positive or negative, that influences their responses. For this reason, it may be preferred that the system not expressly advise the caregiver of the existence of the categories, their descriptions, the pairings, the numbers of categories or pairings, the labels for categories, the uses for the categories and/or of the categorization process, at least prior to the time the caregiver answers all of the queries concerning the caregiver and/or prior to the time the caregiver answers all of the queries concerning the child.

The dimensions and values disclosed herein are not to be understood as being strictly limited to the exact numerical values recited, instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross-referenced or related patent or application, is hereby incorporated by reference in its entirety unless otherwise indicated. The citation of any document is not an admission that it is relevant prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document will govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for facilitating the selection and implementation of a particular pre-determined program to be used by a caregiver and a child for modification of the child's behavior, comprising the steps of:
a) causing the caregiver to respond to a first number of psychometric queries about themself;
b) causing the caregiver to respond to a second number of psychometric queries about the child;
c) categorizing the caregiver into one of a finite third number of pre-determined caregiver categories based upon the caregiver's responses to the first number of psychometric queries;
d) categorizing the child into one of a finite fourth number of pre-determined child categories based on the caregiver's response to the second number of psychometric queries;
e) categorizing the caregiver and child as a pair into one of a finite fifth number of caregiver-child category pairings, wherein:
i) the finite fifth number is a factor of the third number and the fourth number;
ii) the pairings are each unique combinations of one of the pre-determined caregiver categories and one of the pre-determined child categories;
iii) each one of the fifth number of pairings has been pre-assigned at least one of a plurality of particular programs each including one or more behavior modification techniques,
each of the behavior modification techniques having been pre-selected for use by one or more of the caregiver-child category pairings, and having been associated with one of the particular programs, and
each of the particular programs having been pre-assigned to one or more of the caregiver-child category pairings; and
f) providing the caregiver with an information element containing information and/or instructions describing the one or more behavior modification techniques associated with the one of the particular programs assigned to the one of a finite fifth number of caregiver-child category pairings into which the caregiver and child have been categorized; and
g) inducing the caregiver to implement the at least one of a plurality of particular behavior modification techniques with the child.

2. The method of claim 1 wherein the one or more behavior modification techniques about which the caregiver is provided an information element includes use of a physical aid, and the method further comprises providing the caregiver with the physical aid.

3. The method of claim 2 wherein the physical aid is a transitional object.

4. The method of claim 1 wherein prior to the time the caregiver responds to all of the queries about themself, the caregiver is not expressly advised of one of the existence of caregiver categories, the existence of pairings, description(s) of caregiver categories, or of the caregiver categorization step.

5. The method of claim 1 wherein prior to the time the caregiver responds to all of the queries about the child, the caregiver is not expressly advised of one of the existence of child categories, the existence of pairings, description(s) of child categories, or of the child categorization step.

6. The method of claim 1 wherein the modification of the child's behavior is toilet training.

7. The method of claim 6 further comprises the step of causing the caregiver to respond to a sixth number of queries concerning whether the child is continent.

8. The method of claim 1 further comprising the step of providing a kit to the caregiver comprising the information element.

9. The method of claim 2 further comprising the step of providing a kit to caregiver comprising the information element and the physical aid.

10. The method of claim 1 further comprising, prior to the other steps, identifying each of the plurality of particular behavior modification techniques, selecting each of the plurality of behavior modification techniques for use by at least one of the caregiver-child category pairings, and associating each of the plurality of behavior modification techniques with one or more of the plurality of particular programs.

10. The method of claim 10 wherein at least one of the plurality of behavior modification techniques is selected for use by more than one of the fifth number of caregiver-child category pairings.

11. The method of claim 10 wherein at least one of the plurality of behavior modification techniques is selected for use by more than one of the third number of caregiver categories.

12. The method of claim 10 wherein at least one of the plurality of behavior modification techniques is selected for use by more than one of the fourth number of child categories.

13. The method of claim 10 wherein each of the plurality of behavior modification techniques has a component that is unique to one of the fifth number of caregiver-child category pairings.

14. The method of claim 1 further comprising the steps of:
recording data concerning a number of physiological events and/or conditions relating to the child;
modifying the information element based upon the data.

15. The method of claim 14 wherein the physiological events and/or conditions are events of the child's urination.

15. The method of claim 14 wherein the physiological events and/or conditions are events of particular behaviors by the child.

17. A system for facilitating the selection and implementation of a particular pre-determined program to be used by a caregiver and a child for modification of the child's behavior, comprising:
a) a digital storage medium, comprising the following stored information:
i) a first number of psychometric queries about the caregiver;
ii) a second number of psychometric queries about the child;
iii) a finite third number of pre-determined caregiver categories each associated with one or more patterns of responses to the first number of psychometric queries;
iv) a finite fourth number of pre-determined child categories each associated with a one or more patterns of responses to the second number of psychometric queries;
v) a finite fifth number of caregiver-child pairings, wherein
A) the finite fifth number is a factor of the third number and the fourth number,
B) the pairings are each unique combinations of one of the pre-determined caregiver categories and one of the pre-determined child categories;
C) each one of the fifth number of caregiver-child pairings has been pre-assigned at least one of a plurality of particular programs each including one or more behavior modification techniques,
each of the behavior modification techniques having been pre-selected for use by one or more of the caregiver-child pairings, and having been associated with one of the particular programs, and
each of the particular programs having been pre-assigned to one or more of the caregiver-child category pairings; and
b) a processor in operable communication with the digital storage medium;
c) an input device and a display device in operable communication with the processor, wherein:
i) the processor and the display device are operable to display the first and second pluralities of queries in human-readable form;
ii) the processor and the input device are operable to receive human input providing responses to the first and second pluralities of queries;
iii) the processor is operable to select one of the finite third number of pre-determined caregiver categories according to the responses;
iv) the processor is operable to select one of the finite fourth number of pre-determined child categories according to the responses;
v) the processor is operable to select one of the finite fifth number of caregiver-child pairings according to the selected ones of the finite third number of caregiver categories and finite fourth number of child categories;
vi) the processor is operable to identify one of the particular programs that has been pre-assigned to the one of the finite fifth number of caregiver-child pairings; and
vii) the processor and the display device are operable to provide information in human-readable form identifying or describing the particular behavior modification technique that has been associated with the one of the particular programs.
